(19) United States
(12) Patent Application Publication
(10) Pub. No.: US 2026/0156722 A1
(43) Pub. Date: Jun. 4, 2026

(54) INDUCTION ENERGY TRANSMISSION SYSTEM

(71) Applicant: BSH Hausgeräte GmbH, Munich (DE)

(72) Inventors: Antonio Muñoz Fumanal, Utebo (ES); Alberto Dominguez Vicente, Zaragoza (ES); Jorge Villa Lopez, Jaca (Huesca) (ES); Jorge Español Leza, Zaragoza (ES); Jorge Tesa Betes, Zaragoza (ES); Konstantin Iliev, Zaragoza (ES)

(21) Appl. No.: 19/106,239

(22) PCT Filed: Jul. 12, 2023
(86) PCT No.: PCT/EP2023/069381

§ 371 Date: Feb. 25, 2025

(30) Foreign Application Priority Data
Aug. 30, 2022 (EP) 22382808.8

(51) Int. Cl. H05B 6/12; H02J 50/10; H02J 50/70

(52) U.S. Cl. CPC H05B 6/12; H02J 50/10; H02J 50/70

(57) ABSTRACT

An induction energy transmission system includes a placement plate, and a supply unit which is arranged below the placement plate and includes a supply induction element designed to inductively provide energy. The supply unit includes a control parameter set. A placement unit for placement on the placement plate includes a receiving induction element which is designed to receive the inductively provided energy. A control unit controls the supply unit in an operating state and supplies the supply unit with energy. The control unit is designed to modulate in the operating state a control parameter of the control parameter set within a modulation period using a modulation technique.

The invention relates to an induction energy transmission system according to the preamble of claim 1 and a method for operating an induction energy transmission system according to the preamble of claim 14.

Induction energy transmission systems for the inductive transmission of energy from a primary coil of a supply unit to a secondary coil of a placement unit are already known from the prior art. For example, an induction cooktop which is provided for supplying energy to small household appliances, for example a blender, in addition to inductively heating cooking utensils is proposed in the publication US 3,761,668 A. Energy inductively provided by a primary coil of the induction cooktop is partially transmitted to a secondary coil which is integrated in the small household appliance. Due to the large power spectrum for supplying energy to different placement units, control parameters of the supply unit, for example a switching frequency and/or a duty cycle, can be varied over a particularly wide range for controlling and supplying energy to the supply unit, in order to be able to set a supply power for a specific small household appliance as required. Depending on the switching frequency and/or duty cycle, undesired electromagnetic interference, for example noise interference or flicker, can occur, whereby an ease of use is severely restricted for users, which is a drawback.

The object of the invention, in particular but not limited thereto, is to provide a generic device having improved properties relative to an ease of use. The object is achieved according to the invention by the features of claims 1 and 14, while advantageous embodiments and developments of the invention can be found in the dependent claims.

The invention is based on an induction energy transmission system, in particular an induction cooking system, comprising a placement plate, a supply unit that is arranged below the placement plate and includes at least one supply induction element for inductively providing energy, further comprising a control unit which controls the supply unit in an operating state and supplies it with energy, and comprising at least one placement unit to be placed on the placement plate, wherein the placement unit has at least one receiving induction element for receiving the inductively provided energy.

It is proposed that in the operating state the control unit modulates within a modulation period at least one control parameter of a control parameter set of the supply unit by way of at least one modulation technique.

By means of such an embodiment, an induction energy transmission system can be advantageously provided with improved properties relative to an ease of use, in particular relative to a convenient and/or safe and/or low-noise operation. Compliance with EMC standards and/or a flicker conformity can be advantageously achieved by simple technical means. A spectral power density of a switching frequency of the supply unit can be advantageously reduced by means of a frequency modulation. Advantageously, flicker according to a flicker standard, in particular according to the DIN EN 61000-3-3 Standard and/or the IEC Standard 1000-3-3, can be at least substantially avoided, in particular substantially entirely, in particular by an advantageous control of one or more supply induction elements. Moreover, it is possible to avoid a disadvantageous acoustic stress on a user, whereby in particular it is possible to achieve a high degree of ease of use and in particular a positive operating impression for the user, in particular relative to an acoustic quality. Moreover, the requirements for an EMC filter can be advantageously reduced, whereby material costs can be reduced.

The induction energy transmission system has a least one main functionality in the form of a wireless energy transmission, in particular in a wireless energy supply of placement units, for example small household appliances and/or cooking utensils. In an advantageous embodiment, the induction energy transmission system is configured as an induction cooking system with at least one further main function deviating from a purely cooking function, in particular at least one energy supply and an operation of small household appliances. For example, the induction energy transmission system could be configured as an induction oven system and/or as an induction grill system.

In particular, the supply unit could be configured as part of an induction oven and/or as part of an induction grill. In a particularly advantageous embodiment, the induction energy transmission system which is configured as an induction cooking system is configured as an induction cooktop system which comprises at least one cooktop, in particular an induction cooktop. The control unit and the supply unit are thus configured, in particular, as part of the cooktop, in particular the induction cooktop. In a further advantageous embodiment, the induction energy transmission system is configured as a small household appliance supply system which comprises at least one small appliance supply unit and which can be additionally provided for the provision of cooking functions in addition to a main function in the form of an energy supply and an operation of small household appliances. The control unit and the supply unit are thus configured, in particular, as part of the small appliance supply unit.

A “placement plate” is intended to be understood to mean, in particular, a plate-like unit which is provided for placing at least one small household appliance and/or a cooking utensil and/or for positioning at least one food to be cooked. The placement plate could be configured, for example, as a counter-top, in particular as a kitchen counter-top, or as a sub-region of at least one counter-top, in particular at least one kitchen counter-top, in particular of the induction energy transmission system. Alternatively or additionally, the placement plate could also be configured as a cooktop plate. The placement plate which is configured as a cooktop plate could form, in particular, at least one part of a cooktop external housing and could form the cooktop external housing at least to a large extent, in particular, together with at least one external housing unit to which the placement plate, which is configured as a cooktop plate, could be connected, in particular in at least one mounted state. Preferably, the placement plate is produced from a non-metallic material. The placement plate could be formed, for example, at least to a large extent from glass and/or glass ceramic and/or from neolith and/or from dekton and/or from wood and/or from marble and/or from stone, in particular from natural stone, and/or from laminate and/or from plastics and/or from ceramic. In the present document, positional references such as for example “below” or “above” refer to a mounted state of the placement plate, provided this is not explicitly described elsewhere.

A “supply unit” is intended to be understood to mean a unit which in at least one operating state inductively provides energy and which has, in particular, a main functionality in the form of an energy provision. For providing energy, the supply unit has at least one supply induction element which has at least one coil, in particular at least one primary coil, and/or is configured as a coil and which, in particular in the operating state, inductively provides energy. The supply unit could have at least two, in particular at least three, advantageously at least four, particularly advantageously at least five, preferably at least eight and particularly preferably a plurality of supply induction elements which in the operating state in each case could inductively provide energy and namely, in particular, to a single receiving induction element or to at least two or more receiving induction elements of at least one placement unit and/or at least one further placement unit. At least some of the supply induction elements could be arranged in the immediate vicinity of one another, for example in a row and/or in the form of a matrix.

A “control unit” is intended to be understood to mean an electronic unit which in the operating state controls and supplies energy to at least one supply induction element of the supply unit, in particular repeatedly with a switching frequency. Preferably, the control unit for controlling and supplying energy to the at least one supply induction element has at least one inverter which can be configured, in particular, as a resonance inverter and preferably a dual half-bridge inverter. The inverter preferably comprises at least two switching elements which can be controlled individually by the control unit. A “switching element” is intended to be understood to mean an element which is provided to produce and/or to disconnect an electrically conductive connection between two points, in particular contacts of the switching element. Preferably, the switching element has at least one control contact via which it can be switched. Preferably, the switching element is configured as a semi-conductor switching element, in particular as a transistor, for example as a metal oxide semi-conductor field effect transistor (MOSFET) or organic field effect transistor (OFET), advantageously as a bipolar transistor with a preferably insulated gate electrode (IGBT). Alternatively, it is conceivable that the switching element is configured as a mechanical and/or electromechanical switching element, in particular as a relay. Preferably, the control unit comprises a computing unit and, in particular additionally to the computing unit, a storage unit with at least one control program which is stored therein and which is provided to be executed by the computing unit.

A “placement unit” is intended to be understood to mean a unit which in at least one operating state inductively receives energy and converts the inductively received energy at least partially into at least one further energy form for providing at least one main function. For example, in the operating state the energy inductively received by the placement unit could be converted, in particular directly, into at least one further energy form, such as for example into heat. Alternatively or additionally, the placement unit could have at least one electrical consumer, for example an electric motor or the like. The placement unit has at least one receiving induction element for receiving the inductively provided energy. The placement unit could have, for example, at least two, in particular at least three, advantageously at least four, particularly advantageously at least five, preferably at least eight and particularly preferably a plurality of receiving induction elements which, in particular, in the operating state in each case could inductively receive energy, in particular from the supply induction element. The placement unit could be configured, for example, as a cooking utensil. The cooking utensil preferably has at least one food receiving space and in the operating state converts the inductively received energy at least partially into heat for heating food arranged in the food receiving space. Preferably, the placement unit which is configured as a cooking utensil has at least one further unit for providing at least one further function which goes beyond purely heating food and/or deviates from heating food. For example, the further unit could be configured as a temperature sensor or as a mixer unit or the like. Alternatively, the placement unit could be configured as a small household appliance. Preferably, the small household appliance is a location-independent household appliance which has at least the receiving induction element and at least one functional unit which in an operating state provides at least one household appliance function. “Location-independent” is intended to be understood to mean in this context that the small household appliance can be freely positioned in a household by a user and in particular without aids, in particular in contrast to a large household appliance which is fixedly positioned and/or installed at a specific position in a household, such as for example an oven or a refrigerator. Preferably, the small household appliance is configured as a small kitchen appliance and in the operating state provides at least one main function for processing food. The small household appliance, without being limited thereto, could be configured for example as a food processor and/or as a blender and/or as a mixer and/or as a grinder and/or as kitchen scales or as a kettle or as a coffee machine or as a rice cooker or as a milk frother or as a deep fat fryer or as a toaster or as a juicer or as a slicing machine, or the like.

The receiving induction element of the placement unit comprises at least one secondary coil and/or is configured as a secondary coil. In an operating state of the placement unit, the receiving induction element supplies at least one consumer of the placement unit with electrical energy. Moreover, it is conceivable that the placement unit has an energy storage device, in particular an accumulator, which is provided in a charging state for the storage of electrical energy received via the receiving induction element and in a discharging state for the provision of electrical energy to supply a functional unit of the placement unit.

The control parameter set of the supply unit comprises at least two different control parameters by which the control unit controls a quantity of energy inductively provided by at least one of the supply induction elements of the supply unit in the operating state. The control parameter set can comprise, for example, a switching frequency of the supply unit as a first control parameter and a duty cycle of the supply unit as a second control parameter of the supply unit. The control parameter set can also comprise further control parameters of the supply unit which appear expedient to the person skilled in the art. In the operating state the control unit can modulate within the modulation period a plurality, in particular all, of the control parameters, in each case by way of at least one modulation technique. Preferably, the control unit modulates within the modulation period exactly one control parameter of the control parameter set of the supply unit and keeps the other control parameters constant within the modulation period. For example, the control unit can modulate in the modulation period the switching frequency by means of frequency modulation and keep the duty cycle constant. It is also conceivable that the control unit modulates within a first modulation period a first control parameter, for example the switching frequency, and within a second further modulation period following the first modulation period a second control parameter, for example the duty cycle, by means of duty cycle modulation.

A “modulation period” is intended to be understood to mean a time period in which the control unit modulates the at least one control parameter of the control parameter set by the application of at least one modulation technique.

The modulation technique is provided to reduce, preferably to minimize, interference which can be produced in the operating state of the induction energy transmission system, for example by individual peaks of the switching frequency. Interference can be influences which can be perceived by a user and regarded as undesired and/or influences which are not permitted by legal regulations. For example, interference could be configured as flicker. Alternatively or additionally, interference could be undesired acoustic influences, in particular in a frequency range of between 20 Hz and 20 kHz which is able to be perceived by an average human ear. Interference could be caused, in particular, by intermodulations and manifested as perceptible acoustic interference. “Intermodulations” are intended to be understood to mean sum products and/or difference products of individual alternating current frequencies or the nth harmonics thereof, wherein n is a whole number greater than zero. Alternatively or additionally, interference can also be caused by an occurrence of a ripple current, i.e. an alternating current of any frequency and curve shape which is superimposed on a direct current and manifested as an undesired humming sound. Interference in this context does not include any technical malfunctions and/or defects.

In the present document, numerical terms, such as for example “first” and “second”, which are placed in front of specific terms serve merely for differentiating between objects and/or an association between objects with one another and do not imply an existing total number and/or ranking of the objects. In particular, a “second object” does not necessarily imply the presence of a “first object”.

“Provided” is intended to be understood to mean specifically programed, designed and/or equipped. An object being provided for a specific function is intended to be understood to mean that the object fulfills and/or performs this specific function in at least one use state and/or operating state.

It is further proposed that the control parameter set comprises a switching frequency of the supply unit which the control unit modulates within the modulation period by means of at least one frequency modulation. As a result, advantageously interference, for example a noise emission, of the induction energy transmission system can be reduced, in particular minimized, in the operating state by simple technical means and thus an ease of use improved. Preferably, the control unit controls at least one supply induction element for generating a magnetic alternating field and for supplying electrical energy with an electrical alternating current, the switching frequency thereof preferably being in a range of 20 kHz to 150 kHz and particularly preferably in a range of 30 kHz to 75 kHz. A “frequency modulation” is intended to be understood to mean a modulation method on the basis of which the control unit varies the switching frequency. The frequency modulation can comprise, for example, at least one method which is known by the term “frequency spread” or by the English terms “spread spectrum” or “spread spectrum clocking”. Alternatively or additionally, other methods of frequency modulation are conceivable.

It is also proposed that the control parameter set comprises a duty cycle of the supply unit which the control unit modulates within the modulation period by means of at least one duty cycle modulation. As a result, a further possibility can be advantageously provided to reduce, in particular to minimize, interference in the operating state of the induction energy transmission system by simple technical means. A “duty cycle” is intended to be understood to mean in this context a control parameter of the control parameter set of the supply unit which describes a ratio of a pulse duration in which an inverter switching element of the inverter unit is closed and applies an electrical alternating current pulse to at least one supply induction element of the supply unit, and a period duration, in the present case half a period duration of a mains AC voltage of a power supply network, by means of which the induction energy transmission system is supplied with electrical energy in the operating state. The duty cycle can have values, for example, of between 0% and 100%. The duty cycle modulation can comprise, for example, at least one method which is known by the term “pulse width modulation”. Alternatively or additionally, other methods of duty cycle modulation are conceivable.

It is also proposed that the modulation period corresponds to an integer multiple of half a period duration of a mains AC voltage. Since the modulation period is increased relative to the prior art and corresponds to an integer multiple of half the period duration of the mains AC voltage, a temporary computing effort can be advantageously reduced for carrying out the modulation of the at least one control parameter. As a result, it is conceivable for many applications that an application-specific integrated circuit (ASIC chip) can be replaced by simpler and more cost-effective circuits. Due to the cost savings, users in turn can be advantageously provided with particularly inexpensive induction energy transmission systems with the aforementioned advantageous properties relative to safety and/or convenience. The period duration of the mains AC voltage corresponds to the reciprocal of the mains frequency of the power supply network, by means of which the induction energy transmission system is supplied with electrical energy in the operating state. In Europe, a mains AC voltage is typically provided at a mains frequency of 50 Hz, so that half a period duration of the mains AC voltage in this case is 10 ms. In cases in which the induction energy transmission system is supplied with a mains AC voltage at a mains frequency which deviates from 50 Hz, the control unit is provided to adapt the duration of the modulation period to the correspondingly changed period duration of the mains AC voltage and to select it as a corresponding integer multiple of half the changed period duration.

It is also proposed that the modulation period comprises at least two modulation intervals which, in particular, differ from one another and which correspond in each case to an integer multiple of half a period duration of a mains AC voltage. As a result, a particularly accurate modulation of the at least one control parameter can be advantageously achieved. Preferably, the modulation period comprises a plurality of modulation intervals which are in particular different from one another and which in each case correspond to an integer multiple of half a period duration of a mains AC voltage. It might be conceivable that the at least two modulation intervals correspond to different multiples of half the period duration of the mains AC voltage. For example, a first modulation interval could correspond to two times, and a further modulation interval to four times, of half the period duration of the mains AC voltage. Preferably, all of the modulation intervals within a modulation period correspond in each case to the same multiple, particularly preferably two times, of half the period duration of the mains AC voltage. The modulation intervals can differ from one another, for example, relative to an amount and/or relative to a sign of a variation in the at least one control parameter. For example, in the first modulation interval the control unit could vary the at least one control parameter by a specific first amount and in a further modulation interval the control unit could vary the at least one control parameter by a further amount which is, for example, larger or smaller than the first amount and/or has an opposing sign relative to the first amount.

It is further proposed that the control unit modulates within the modulation period at least one control parameter of the control parameter set on the basis of at least one predefined modulation profile. As a result, interference can be advantageously reduced in a particularly targeted manner. Moreover, a computing effort for the control unit can be advantageously reduced. The predefined modulation profile can be understood to mean a basic time path of the modulation within a modulation period which is stored, in particular, in the storage unit of the control unit. The predefined modulation profile could define, for example, a frequency value range of the switching frequency and/or a duty cycle range of the duty cycle in which the control unit modulates within the modulation period the switching frequency and/or the duty cycle. For example, the predefined modulation profile could comprise a maximum and/or a minimum switching frequency and/or a maximum and/or minimum duty cycle which cannot be exceeded or fallen below by the control unit or is not intended to be exceeded or fallen below. Alternatively or additionally, the modulation profile, for example, could contain a maximum and/or minimum percentage variation of an initial switching frequency and/or an initial duty cycle. It is also conceivable that the modulation profile, in particular, comprises experimentally determined specific switching frequency values, in particular specific switching frequency values, of individual, in particular all, modulation intervals of the modulation period and/or in particular experimentally determined specific duty cycles, in particular specific duty cycles of individual, in particular all, modulation intervals of the modulation period. Preferably, a plurality of different predefined modulation profiles are stored in the storage unit of the control unit, said predefined modulation profiles being able to be automatically recalled by the control unit, in particular based on a selection made by a user of a specific operating mode and/or a target power provided via at least one supply induction element of the supply unit for operating the placement unit. Alternatively or additionally, it might also be conceivable that in the operating state the placement unit wirelessly transmits at least one modulation profile, which is designed in particular specifically for the placement unit, to the control unit by means of a communication unit. The control unit “modulating on the basis of at least one predefined modulation profile” the at least one control parameter of the control parameter set is intended to be understood to mean that the control unit at least takes into account the predefined modulation profile for the modulation of the at least one control parameter of the control parameter set. The predefined modulation profile can be provided as a template for the modulation of the at least one control parameter of the control parameter set to be carried out by the control unit, wherein the control unit can change the modulation of the at least one control parameter of the control parameter set based on the predefined modulation profile and, in particular, adapt to an individual operating situation, for example to a specific type of placement unit and/or a specific operating mode and/or a number of supply induction elements to be operated at the same time and/or a target power selected by a user or the like. It is conceivable that the control unit is provided to vary the modulation profile at least on the basis of a parameter relating to the placement unit. The modulation technique can be advantageously adapted particularly effectively by means of such an embodiment to an individual operating situation, in particular to an individual operation of different placement units. It is conceivable that the control unit has at least one sensor unit for detecting the parameter relating to the placement unit. The parameter relating to the placement unit could comprise, for example, a temperature of the placement unit and/or a region of the placement plate on which the placement unit in the operating state is placed and/or an operating time of the placement unit, or the like. Preferably, the parameter relating to the placement unit is an electrical parameter of the placement unit and/or an influence of the placement unit on at least one electrical parameter of the supply unit. The parameter relating to the placement unit could be, for example, an electrical parameter of the receiving induction element, in particular an inductance and/or an electrical resistance and/or an impedance and/or a capacitance and/or electrical voltage and/or current strength and/or electrical power and/or a resonance frequency of the receiving induction element and/or at least one component connected to the receiving induction element. Preferably, the electrical parameter of the placement unit comprises at least one electrical power of the placement unit, in particular a minimum power and/or a maximum power, preferably a target power currently set by a user. Moreover, the parameter can comprise an influence of the placement unit on an impedance of at least one supply induction element of the supply unit. As a result, a desired target power of the placement unit can be advantageously set particularly efficiently and accurately. Due to the modulation of the at least one control parameter, the impedance of the at least one supply induction element of the supply unit changes and can have an excess in some portions and a deficit in some portions within the modulation period relative to a desired impedance which corresponds to the set target power. Preferably, the control unit varies the modulation profile such that the impedance of the supply induction element is constant when averaged over the modulation period.

It is further proposed that the control unit modulates within a further modulation period at least one control parameter of the control parameter set on the basis of at least one further modulation profile which is an inverse of the predefined modulation profile. An energy efficiency can be advantageously improved by means of such an embodiment. In particular, switching losses from inverter switching elements of the inverter can be reduced when the inverter switching elements are arranged in a dual half-bridge configuration and the control unit on the basis of the predefined modulation profile modulates a duty cycle as a control parameter of the control parameter set by means of a duty cycle modulation and modulates within the further modulation period the duty cycle on the basis of the further modulation profile which is an inverse of the predefined modulation profile, since inverter switching elements provide a maximum power in a dual half-bridge configuration at a duty cycle of 50%.

The modulation profile could be, for example, a rectangular or saw tooth-shaped profile and have discontinuous points with larger jumps in the at least one control parameter of the control parameter set. In an advantageous embodiment, however, it is proposed that the modulation profile can be described by a continuous mathematical function. As a result, advantageously an occurrence of flicker can be reduced, preferably minimized. Since a change to the at least one control parameter of the control parameter set is discrete in electrical components and thus cannot take place in infinitesimally small steps, as might be required according to a strict mathematical definition of continuity, the modulation profile in this context can be considered to be continuous only in the context of a resolution of the at least one control parameter of the control parameter set, i.e. a minimum step of change between two immediately following steps of the at least one control parameter of the control parameter set. Preferably, the minimum step of the control parameter between two immediately following control parameter values of the modulation profile which can be described by a continuous mathematical function, in the case of a control parameter configured as switching frequency, is at least 1 Hz, advantageously at least 2 Hz, particularly advantageously at least 4 Hz and a maximum of 8 Hz, and in the case of a control parameter configured as a duty cycle at least 1%, advantageously at least 2%, particularly advantageously at least 3% and a maximum of 5%. In particular, the continuous mathematical function contains all discrete points of the modulation profile as functional values, so that modulation profile can be described by the continuous mathematical function.

It is further proposed that the modulation profile within the modulation period has a linear path at least in some portions. Advantageously, interference during an operation of the induction energy transmission system, such as acoustic interference or the like, can be particularly reliably reduced, preferably minimized by a modulation profile which is linear at least in some portions. “A linear path at least in some portions” is intended to be understood to mean that the modulation profile has at least a portion consisting of a plurality of at least three successive modulation intervals in which the at least one control parameter of the control parameter set is changed by the control unit in each case by the same amount. For example, the modulation period could have a portion which consists of at least three successive modulation intervals in which the control unit raises or lowers the at least one control parameter of the control parameter set in each case by a first amount. The modulation profile can have a plurality of portions which have in each case a linear path, wherein the linear portions could have different slopes relative to one another. For example, the control unit could raise or lower the at least one control parameter of the control parameter set in a first linear portion of the modulation profile, consisting of at least three successive modulation intervals, in each of the modulation intervals by a first amount and in a subsequent second linear portion of the modulation profile, consisting of at least three further successive modulation intervals, in each case by a second amount which is different from the first amount.

In a further advantageous embodiment it is proposed that the modulation profile has an exponential path at least in some portions within the modulation period. Advantageously, interference during an operation of the induction energy transmission system, such as acoustic interference or the like, can be reduced particularly efficiently, preferably minimized, by a modulation profile which is exponential at least in some portions. An “exponential path at least in some portions” is intended to be understood to mean that the modulation profile has a plurality of at least three successive modulation intervals in which the at least one control parameter of the control parameter set is changed by the control unit in each case by different values, the path thereof being able to be described by an exponential function. For example, the modulation period could have a portion which consists of at least three successive modulation intervals in which the control unit raises or lowers the at least one control parameter of the control parameter set in the first of the successive modulation intervals by a first amount, in the second of the successive modulation intervals by a second amount which corresponds to two times the first amount, and in the third of the successive modulation intervals by a third amount which corresponds to four times the first amount.

It is also proposed that the modulation profile within the modulation period is mirror-symmetrical at least in some portions. Advantageously, an occurrence of inference, in particular flicker, can be further reduced thereby. Advantageously, a desired target power for supplying the placement unit can also be adjusted particularly accurately. The modulation profile which is mirror-symmetrical at least in some portions could have, for example, a first portion in which the at least one control parameter of the control parameter set has, for example, a linear or exponential path which can be described by a first mathematical function and a second portion which immediately follows the first portion and which can be described by a second mathematical function which can be converted into the first mathematical function by reflection on an axis of symmetry.

It is further proposed that the induction energy transmission system has a cooktop which comprises the control unit and the supply unit. An induction energy transmission system which is configured as an induction cooking system can be provided with the aforementioned advantageous properties by means of such an embodiment, said induction energy transmission system also permitting conventional inductive heating of cooking utensils, in addition to the inductive supply of energy by the supply unit to placement units which are configured as small household appliances.

In an alternative advantageous embodiment, it is proposed that the induction energy transmission system has a small appliance supply unit which comprises the control unit and the supply unit. An induction energy transmission system can be provided with the aforementioned advantageous properties and with a particularly high level of flexibility and functionality by means of such an embodiment. In this embodiment, the placement plate is preferably configured as kitchen counter-top. As a result, advantageously an enthusiasm for inductive energy transmission can be increased when the placement plate is configured as a kitchen counter-top, since some components of the induction energy transmission system, in particular the small appliance supply unit, remain completely invisible to a user below the kitchen counter-top and thus can create the impression that the placement unit is operated without any energy source.

The invention is also based on a method for operating an induction energy transmission system, in particular as claimed in one of the preceding claims, comprising a placement plate, a supply unit that is arranged below the placement plate and includes at least one supply induction element for inductively providing energy, and comprising at least one placement unit to be placed on the placement plate, wherein the placement unit has at least one receiving induction element for receiving the inductively provided energy.

It is proposed that at least one control parameter of a control parameter set of the supply unit is modulated within a modulation period by way of at least one modulation technique. The induction energy transmission system can be advantageously operated particularly efficiently by means of such an embodiment. The induction energy transmission system can also be advantageously operated particularly safely and/or conveniently, in particular with low noise and with compliance to EMC and flicker standards.

The induction energy transmission system is not intended to be limited to the above-described use and embodiment. In particular, the induction energy transmission system can have a number of individual elements, components and units which deviates from a number mentioned herein for fulfilling a mode of operation described herein.

Further advantages are found in the following description of the drawing. Two exemplary embodiments of the invention are shown in the drawing. The drawing, the description and the claims contain numerous features in combination. The person skilled in the art will also expediently consider the features individually and combine them to form further meaningful combinations.

### IN THE DRAWING

FIG. 1 shows an induction energy transmission system with a placement plate, a supply unit, a control unit and two placement units which are placed on the placement plate, in a schematic view,

FIG. 2 shows a schematic diagram for representing a time path of a control parameter of a control parameter set by means of which the control unit controls the supply unit in an operating state,

FIG. 3 shows a schematic diagram for representing a modulation period within which the control unit in a first configuration modulates at least one control parameter of the control parameter set by way of at least one modulation technique,

FIG. 4 shows a schematic diagram for representing a modulation profile, on the basis of which the control unit in the first configuration modulates within the modulation period the at least one control parameter of the control parameter set,

FIG. 5 shows a schematic diagram for representing a first further modulation profile, on the basis of which the control unit in the first configuration modulates in a first further modulation period the at least one control parameter of the control parameter set,

FIG. 6 shows a schematic diagram for representing a second further modulation profile, on the basis of which the control unit in the first configuration modulates in a second further modulation period the at least one control parameter of the control parameter set,

FIG. 7 shows two schematic diagrams for representing a third further modulation profile, on the basis of which the control unit in the first configuration modulates in a third further modulation period the at least one control parameter of the control parameter set,

FIG. 8 shows two schematic diagrams for representing a fourth further modulation profile, on the basis of which the control unit in the first configuration modulates in a fourth further modulation period the at least one control parameter of the control parameter set,

FIG. 9 shows a schematic diagram for representing modulation periods within which the control unit in a second configuration modulates at least one control parameter of the control parameter set by way of at least one modulation technique on the basis of at least one predefined modulation profile,

FIG. 10 shows a schematic diagram for representing further modulation periods within which the control unit in the second configuration modulates at least one control parameter of the control parameter set by way of at least one modulation technique on the basis of at least one predefined modulation profile,

FIG. 11 shows two schematic diagrams for representing one of the further modulation profiles, on the basis of which the control unit in the first configuration modulates in one of the further modulation periods the at least one control parameter of the control parameter set,

FIG. 12 shows a schematic diagram for representing a further modulation period within which the control unit in the second configuration modulates the at least one control parameter of the control parameter on the basis of at least one further modulation profile which is an inverse of the further modulation profile,

FIG. 13 shows a schematic process flow diagram of a method for operating the induction energy transmission system and

FIG. 14 shows a further exemplary embodiment of an induction energy transmission system with a placement plate, a supply unit, a control unit and two placement units which are placed on the placement plate, in a schematic view.

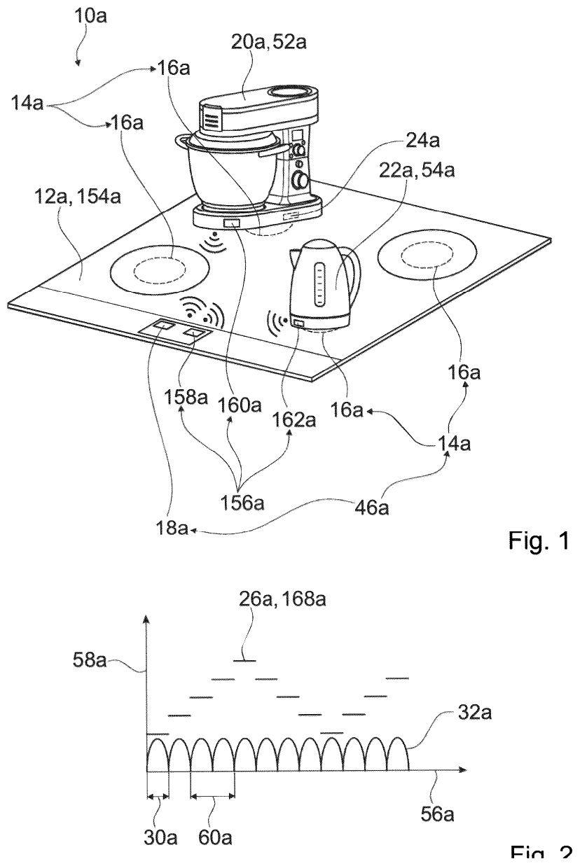

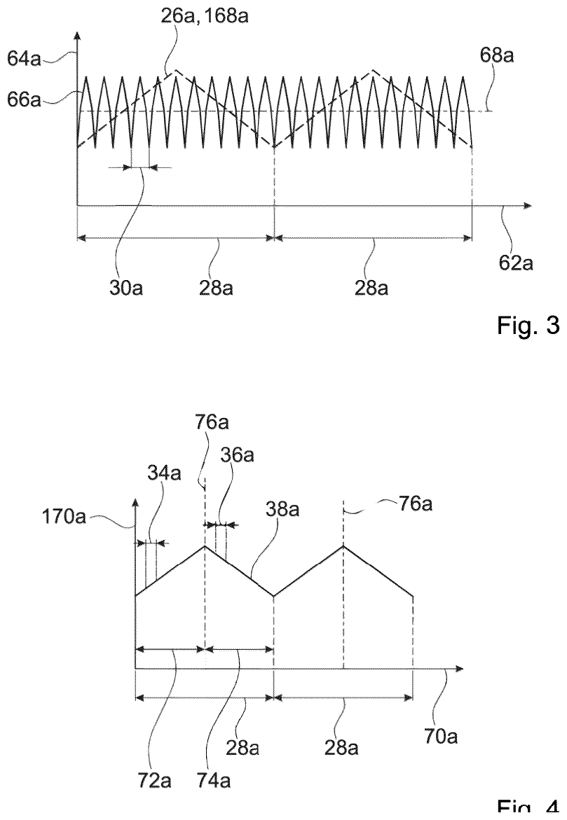

FIG. 1 shows an induction energy transmission system 10a in a schematic view. The induction energy transmission system 10a comprises a placement plate 12a and a supply unit 14a. The supply unit 14a is arranged below the placement plate 12a and has at least one supply induction element 16a for inductively providing energy. In the present case, the supply unit 14a comprises a total of four supply induction elements 16a which are arranged below the placement plate 12a. The induction energy transmission system 10a has a control unit 18a which controls the supply unit 14a in the operating state and supplies it with energy. The control unit 18a comprises an inverter (not shown) for controlling and supplying energy to the supply unit 14a. In the operating state the control unit 18a supplies the supply unit 14a with electrical energy in the form of a supply alternating current 66a (see FIG. 3), the frequency thereof corresponding to a switching frequency 168a (see FIG. 3) by which the control unit 18a operates the inverter.

The induction energy transmission system 10a is configured in the present case as an induction cooking system and comprises a cooktop 46a. The cooktop 46a is configured as an induction cooktop. In the present case, the placement plate 12a is configured as a cooktop plate 154a. The cooktop plate 154a is part of the cooktop 46a. In the present case, the cooktop 46a comprises the control unit 18a and the supply unit 14a.

The induction energy transmission system 10a comprises at least one placement unit 20a to be placed on the placement plate 12a. The placement unit 20a has at least one receiving induction element 24a. The receiving induction element 24a is provided for receiving an inductively provided energy. In the present case, the receiving induction element 24a is provided for receiving the energy inductively provided by the supply induction element 16a. In the present case, the induction energy transmission system 10a comprises the placement unit 20a and a further placement unit 22a. The placement unit 20a is configured as a small household appliance and namely as a food processor 52a and is provided, amongst other things, for blending and/or mixing food. The further placement unit 22a is configured as a further small household appliance and namely as a kettle 54a.

The induction energy transmission system 10a has a communication unit 156a for a wireless communication between the control unit 18a and the placement unit 20a and/or the further placement unit 22a. The communication unit 156a has a communication element 158a which is connected to the control unit 18a and two further communication elements 160a, 162a which are arranged in the placement unit 20a or in the further placement unit 22a. In the present case the communication unit 156a is configured as an NFC communication unit and provided for wireless communication by NFC between the control unit 18a and the placement unit 20a and/or the further placement unit 22a.

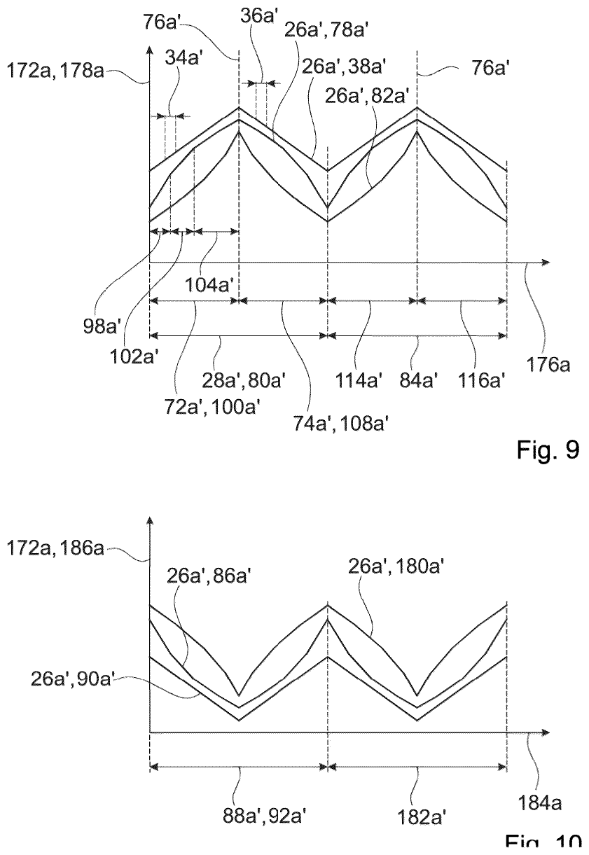

FIG. 2 shows a schematic diagram for representing by way of example a time path of a control parameter 26a of a control parameter set of the supply unit 14a. In the operating state, the control unit 18a controls the supply unit 14a on the basis of the control parameter set. The control parameter set comprises in the present case at least two control parameters 26a, 26a′. The control parameter set comprises a switching frequency 168a of the supply unit 14a as a control parameter 26a. The control parameter set also comprises a duty cycle 172a (see FIG. 9) of the supply unit 14a as a control parameter 26a′ (see FIG. 9).

A time is plotted in milliseconds on an x-axis 56a of the diagram of FIG. 2. The switching frequency 168a of the supply unit 14a is plotted in kilohertz on a y-axis 58a of the diagram. A graph shows a time path of a mains AC voltage 32a which is rectified by a rectifier (not shown) of the control unit 18a and namely such that an instantaneous value of the mains AC voltage 32a changes within half a period duration 30a, but the mains AC voltage 32a does not change its electrical polarity within a period duration 60a consisting of two half period durations 30a. In the present case, the mains AC voltage 32a has a frequency of 50 Hz so that the period duration 60a lasts 20 milliseconds and half the period duration 30a accordingly lasts 10 milliseconds.

In the operating state, the control unit 18a modulates within a modulation period 28a at least one control parameter 26a, 26′ of the supply unit 14a (see FIG. 3) by way of at least one modulation technique. In a first configuration the control unit 18a modulates the switching frequency 168a of the supply unit 14a by means of a frequency modulation.

In FIG. 3 a diagram is shown for representing schematically the modulation period 28a within which the control unit 18a in the first configuration modulates the switching frequency 168a by means of at least one frequency modulation. A time is plotted in milliseconds on an x-axis 62a of the diagram. The switching frequency 168a is plotted in kilohertz and the supply alternating current 66a is plotted in amperes on a y-axis 64a. The modulation period 28a corresponds to an integer multiple, in the present case eleven times, of half the period duration 30a of the mains AC voltage 32a. Averaged over the modulation period 28a the switching frequency 168a corresponds to an average switching frequency 68a which corresponds to an average power inductively provided by the supply induction element 16a.

FIG. 4 shows a diagram for representing a predefined modulation profile 38a, on the basis of which the control unit 18a modulates within the modulation period 28a the at least one control parameter 26a of the control parameter set, in the present case the switching frequency 168a. A time is plotted in milliseconds on an x-axis 70a of the diagram. The switching frequency 168a is plotted in kilohertz on a y-axis 170a of the diagram.

The modulation period 28a comprises a plurality of successive modulation intervals 34a, 36a which correspond in each case to an integer multiple of half the period duration 30a of the mains AC voltage 32a. By way of example, two modulation intervals 34a, 36a which are, in particular, different from one another are illustrated in FIG. 4. The control unit 18a increases the switching frequency 168a within the modulation interval 34a. The control unit 18a lowers the switching frequency 168a within the modulation interval 36a.

In the operating state, the control unit 18a in the first configuration modulates the switching frequency 168a on the basis of the predefined modulation profile 38a. The modulation profile 38a can be described by a continuous mathematical function. The modulation profile 38a has a path which is linear at least in some portions within the modulation period 28a. The modulation profile 38a has a linear and continuously rising path with a rising switching frequency 168a within a first portion 72a of the modulation period 28a. The modulation profile 38a has a linear and continuously falling path with a reducing switching frequency 168a within a second portion 74a. The modulation profile 38a is mirror-symmetrical at least in some portions. In the present case, the modulation profile 38a is mirror-symmetrical relative to an axis of symmetry 76a so that the path of the modulation profile 38a in the second portion 74a results from a reflection of the path in the first portion 72a on the axis of symmetry 76a.

After the modulation period 28a has expired, it is repeated again and the control unit 12a modulates the switching frequency 168a again on the basis of the modulation profile 38a.

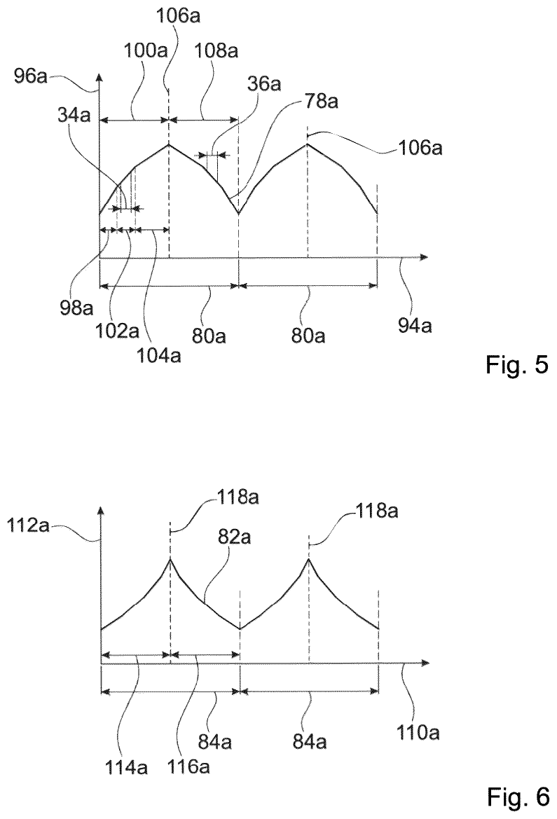

FIG. 5 shows a schematic diagram for representing a first further modulation profile 78a, on the basis of which the control unit 18a modulates within a first further modulation period 80a following the modulation period 28a the at least one control parameter 26a of the control parameter set, in the present first configuration the switching frequency 168a, by way of at least one modulation technique, in the present case a different frequency modulation. The first further modulation period 80a corresponds to an integer multiple of half the period duration 30a of the mains AC voltage 32a. A time is plotted in milliseconds on an x-axis 94a of the diagram. The switching frequency 168a is plotted in kilohertz on a y-axis 96a of the diagram.

The first further modulation profile 78a can be described by a continuous mathematical function. The first further modulation profile 78a has a path which is linear at least in some portions within the first further modulation period 80a. The first further modulation profile 78a has a linear and continuously rising path with increasing switching frequency 168a within the first sub-portion 98a of a first portion 100a of the first further modulation period 80a. The first further modulation profile 78a has a linear and continuously rising path with a flatter rise of the switching frequency 168a relative to the first sub-portion 98a within a second sub-portion 102a of the first portion 100a of the first further modulation period 80a. The first further modulation profile 78a has a linear and substantially continuous path with a flatter rise of the switching frequency 168a relative to the second sub-portion 102a within a third sub-portion 104a of the first portion 100a of the first further modulation period 80a.

The first further modulation profile 78a is mirror-symmetrical at least in some portions. In the present case, the first further modulation profile 78a is mirror-symmetrical relative to an axis of symmetry 106a so that a path of the first further modulation profile 78a in a second portion 108a results from a reflection of the path in the first portion 100a on the axis of symmetry 106a.

FIG. 6 shows a schematic diagram for representing a second further modulation profile 82a on the basis of which the control unit 18a modulates within a second further modulation period 84a following the first further modulation period 78a the at least one control parameter 26a of the control parameter set, in the present first configuration the switching frequency 168a, by way of at least one modulation technique, in the present case a further different frequency modulation. The second further modulation period 84a corresponds to an integer multiple of half the period duration 30a of the mains AC voltage 32a. A time is plotted in milliseconds on an x-axis 110a of the diagram. The switching frequency 168a is plotted in kilohertz on a y-axis 112 of the diagram.

The second further modulation profile 82a can be described by a continuous mathematical function. The second further modulation profile 82a has an exponential path at least in some portions within the second further modulation period 84a. The second further modulation profile 82a has a rising path with an exponentially increasing switching frequency 168a within a first portion 114a of the second further modulation period 84a. The second further modulation profile 82a has a rising path with an exponentially reducing switching frequency 168a within a second portion 116a of the second further modulation period 84a.

The second further modulation profile 82a is mirror-symmetrical at least in some portions. In the present case, the second further modulation profile 82a is mirror-symmetrical relative to an axis of symmetry 118a so that a path of the second further modulation profile 82a in the second portion 116a results from a reflection of the path in the first portion 114a on the axis of symmetry 118a.

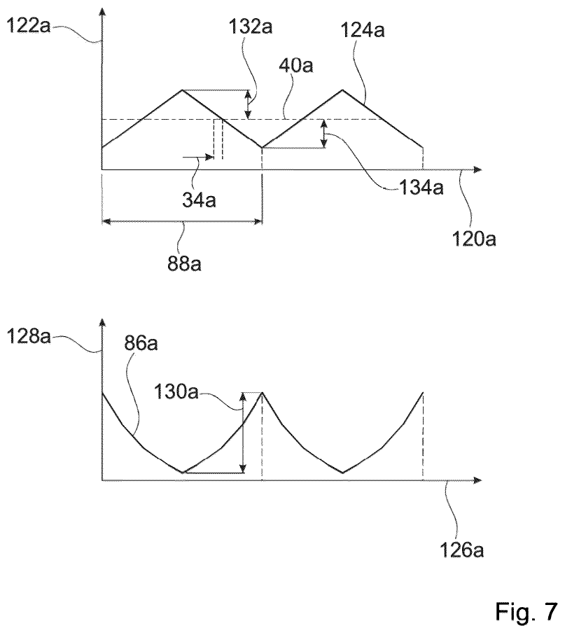

FIG. 7 shows two schematic diagrams for representing a third further modulation profile 86a on the basis of which the control unit 18a modulates within a third further modulation period 88a following the second further modulation period 84a the at least one control parameter 26a of the control parameter set, in the present first configuration the switching frequency 168a, by way of at least one modulation technique, in the present case a further different frequency modulation. The third further modulation period 88a corresponds to an integer multiple of half the period duration 30a of the mains AC voltage 32a. A time is plotted in milliseconds on an x-axis 120a of an upper diagram. A power 124a is plotted in watts on a y-axis 122a of the upper diagram. The time is plotted in milliseconds on an x-axis 126a of a lower diagram. The switching frequency 168a is plotted in kilohertz on a y-axis 128a of the lower diagram.

The control unit 18a is provided to vary the third further modulation profile 86a at least on the basis of one of the parameters 40a relating to the placement unit 20a or the further placement unit 22a. The parameter 40a in the present case is a target power set by a user, which is intended to be provided by the supply induction element 16a for supplying the placement unit 20a. A general path of the third further modulation profile 86a is continuous and in some portions linear and an inverse of the first further modulation profile 78a (see FIG. 5). On the basis of the parameter 40a the control unit 18a in the operating state varies a frequency value range 130a of the third further modulation profile 86a, resulting in the path of the power 124a shown in the upper diagram. Due to the frequency modulation of the switching frequency 168a the power 124a changes and has an excess 132a in some portions and a deficit 134a in some portions, so that when considered over the third further modulation period 88a the power 124a corresponds on average to the target power set by the user.

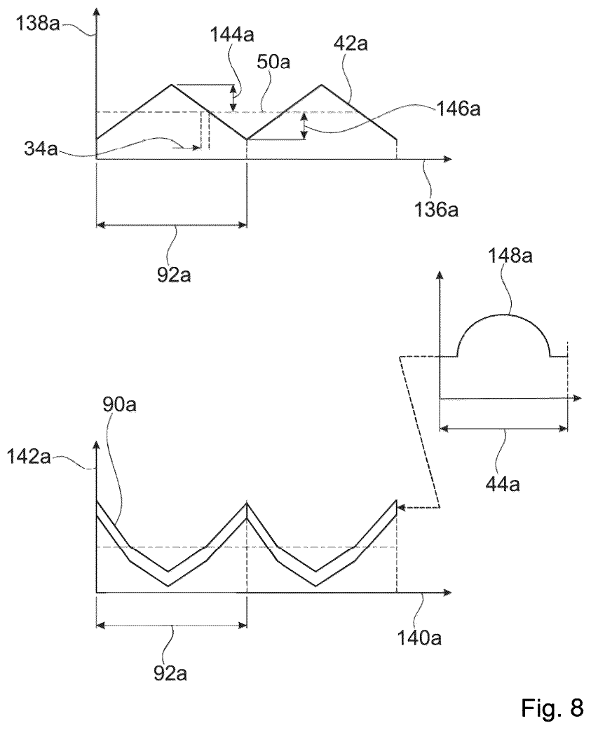

FIG. 8 shows two schematic diagrams for representing a fourth further modulation period 90a on the basis of which the control unit 18a modulates within a fourth further modulation period 92a following the third further modulation period 88a the at least one control parameter 26a of the control parameter set, in the present first configuration the switching frequency 168a, by way of at least one modulation technique, in the present case a further different frequency modulation. The fourth further modulation period 92a corresponds to an integer multiple of half the period duration 30a of the mains AC voltage 32a. A time is plotted in milliseconds on an x-axis 140a of a lower diagram. The switching frequency 168a is plotted in kilohertz on a y-axis 142a of the lower diagram. The time is plotted in milliseconds on an x-axis 136a of an upper diagram. An impedance 42a of the supply induction element 16a is plotted on a y-axis 138a of the upper diagram.

The fourth further modulation profile 90a substantially differs from the third further modulation profile 86a relative to a parameter 50a which relates to the placement unit 20a and which the control unit 18a uses as a basis for a variation of the fourth further modulation profile 90a. The parameter 50a comprises an influence of the placement unit 20a on the impedance 42a of the supply induction element 16a. On the basis of the parameter 50a the control unit 18a varies the fourth further modulation profile 90a, resulting in the path of the impedance 42a shown in the upper diagram. Due to the frequency modulation of the switching frequency 168a the impedance 42a changes and has an excess 144a in some portions and a deficit 146a in some portions. The control unit 18a varies the fourth further modulation profile 90a such that on average the impedance 42a is constant when considered over the fourth further modulation period 92a.

In the operating state the control unit 18a additionally modulates the switching frequency 168a within an intermediate modulation period 44a which corresponds to a maximum of half the period duration 30a of the mains AC voltage 32a, by means of at least one further frequency modulation. In the operating state, in addition to the above-described frequency modulation on the basis of the fourth further modulation profile 90a, the control unit 18a briefly varies the switching frequency 168a within the intermediate modulation period 44a and namely within half the period duration 30a of the mains AC voltage 32a, on the basis of an intermediate modulation profile 148a, shown in FIG. 8, in order to prevent an occurrence of flicker.

FIG. 9 shows a schematic diagram for representing the modulation periods 28a′, 80a′, 84a′ within which the control unit 18a in a second configuration modulates at least one control parameter 26a′ of the control parameter set of the supply unit 14a by way of at least one modulation technique on the basis of at least one predefined modulation profile 38a′, 78a′, 82a′. The control unit 18a in the second configuration modulates the duty cycle 172a as a control parameter 26a′ of the supply unit 14a by means of at least one duty cycle modulation. A time is plotted in milliseconds on an x-axis 176a of the diagram. The duty cycle 172a of the supply unit 14a is plotted in percentage values on a y-axis 178a of the diagram.

The control unit 18a modulates within a modulation period 28a′ the duty cycle 172a by means of duty cycle modulation on the basis of a predefined modulation profile 38a′. The modulation period 28a′ corresponds to an integer multiple, in the present case eleven times, of half the period duration 30a of the mains AC voltage 32a (see FIG. 2). Averaged over the modulation period 28a′, the duty cycle 172a′ corresponds to an average duty cycle which corresponds to an average power inductively provided by the supply induction element 16a.

The modulation period 28a′ comprises a plurality of successive modulation intervals 34a′, 36a′ which correspond in each case to an integer multiple of half the period duration 30a of the mains AC voltage 32a (see FIG. 2). Two modulation intervals 34a′, 36a′, which in particular differ from one another, are illustrated by way of example in FIG. 9. The control unit 18a increases the duty cycle 172a within the modulation interval 34a′. The control unit 18a lowers the duty cycle 172a within the modulation interval 36a′. The modulation profile 38a′ can be described by a continuous mathematical function. The modulation profile 38a′ has a linear path at least in some portions within the modulation period 28a′. The modulation profile 38a′ has a linear and continuously rising path with an increasing duty cycle 172a within the first portion 72a′ of the modulation period 28a′. The modulation profile 38a′ has a linear and continuously falling path with a reducing duty cycle 172a within a second portion 74a′. The modulation profile 38a′ is mirror-symmetrical at least in some portions. In the present case, the modulation profile 38a′ is mirror-symmetrical relative to an axis of symmetry 76a′, so that the path of the modulation profile 38a′ in the second portion 74a′ results from a reflection of the path in the first portion 72a′ on the axis of symmetry 76a′.

A first further modulation profile 78a′ is shown in the diagram of FIG. 9, on the basis of which the control unit 18a modulates within a first further modulation period 80a′ the at least one control parameter 26a′ of the control parameter set, in the present second configuration the duty cycle 172a, by way of at least one modulation technique, in the present case a different duty cycle modulation. The first further modulation period 80a′ could chronologically follow the modulation period 28a′, for example. The first further modulation profile 78a′ can be described by a continuous mathematical function. The first further modulation profile 78a′ has a linear path at least in some portions within the first further modulation period 80a′. The first further modulation profile 78a′ has a linear and continuously rising path with an increasing duty cycle 172a within a first sub-portion 98a′ of a first portion 100a′ of the first further modulation period 80a'. The first further modulation profile 78a′ has a linear and continuously rising path with a flatter rise of the duty cycle 172a relative to the first sub-portion 98a′ within a second sub-portion 102a′ of the first portion 100a′ of the first further modulation period 80a′. The first further modulation profile 78a′ has a linear and substantially continuous path with a flatter rise of the duty cycle 172a relative to the second sub-portion 102a′ within a third sub-portion 104a′ of the first portion 100a′ of the first further modulation period 80a′.

The first further modulation profile 78a′ is mirror-symmetrical at least in some portions. In the present case, the first further modulation profile 78a′ is mirror-symmetrical relative to the axis of symmetry 76a′ so that a path of the first further modulation profile 78a′ in a second sub-portion 108a′ results from a reflection of the path in the first portion 100a′ on the axis of symmetry 76a.

A second further modulation profile 82a′ is also shown in the diagram of FIG. 9, on the basis of which the control unit 18a modulates within a second further modulation period 84a′ the at least one control parameter 26a′ of the control parameter set, in the present second configuration the duty cycle 172a, by way of at least one modulation technique, in the present case a further different duty cycle modulation. The second further modulation period 84a′ corresponds to an integer multiple of half the period duration 30a of the mains AC voltage 32a (see FIG. 2). The second further modulation period 84a′ could chronologically follow the first further modulation period 80a′, for example.

The second further modulation profile 82a′ can be described by a continuous mathematical function. The second further modulation profile 82a′ has an exponential path at least in some portions within the second further modulation period 84a′. The second further modulation profile 82a′ has a continuous path with an exponentially increasing duty cycle 172a within a first portion 114a′ of the second further modulation period 84a′. The second further modulation profile 82a′ has a continuous path with an exponentially reducing duty cycle 172a within a second portion 116a′ of the second further modulation period 84a′.

The second further modulation profile 82a′ is mirror-symmetrical at least in some portions. In the present case, the second further modulation profile 82a′ is mirror-symmetrical relative to the axis of symmetry 76a′, so that a path of the second further modulation profile 82a′ in the second portion 116a′ results from a reflection of the path in the first portion 114a′ on the axis of symmetry 76a′.

FIG. 10 shows a schematic diagram for representing further modulation periods 88a′, 92a′, 182a′ within which the control unit 18a in the second configuration modulates at least one control parameter 26a′ of the control parameter set of the supply unit 14a by way of at least one modulation technique, on the basis of at least one further modulation profile 86a′, 90a′, 180a′ which is an inverse of the predefined modulation profile 38a′, 78a′, 82a′. A time is plotted in milliseconds on an x-axis 184a of the diagram. The duty cycle 172a of the supply unit 14a is plotted in percentage values on a y-axis 186a of the diagram.

The control unit 18a modulates within a third further modulation period 88a′ the duty cycle 172a by means of duty cycle modulation on the basis of a third further modulation profile 86a′. The third further modulation profile 86a′ is an inverse of the first further modulation profile 78a′ (see FIG. 9). The third further modulation period 84a′ could chronologically follow the first further modulation period 80a′ (see FIG. 9), for example.

The control unit 18a modulates within a fourth further modulation period 92a′ the duty cycle 172a by means of duty cycle modulation on the basis of a fourth further modulation profile 92a′. The fourth further modulation profile 92a′ is an inverse of the modulation profile 38a′ (see FIG. 9). The fourth further modulation period 92a′ could chronologically follow the modulation period 28a′ (see FIG. 9), for example.

The control unit 18a modulates within a fifth further modulation period 182a′ the duty cycle 172a by means of duty cycle modulation on the basis of a fifth further modulation profile 180a′. The fifth further modulation profile 180a′ is an inverse of the second further modulation profile 82a′ (see FIG. 9). The fifth further modulation period 182a′ could chronologically follow the second further modulation period 84a′ (see FIG. 9), for example.

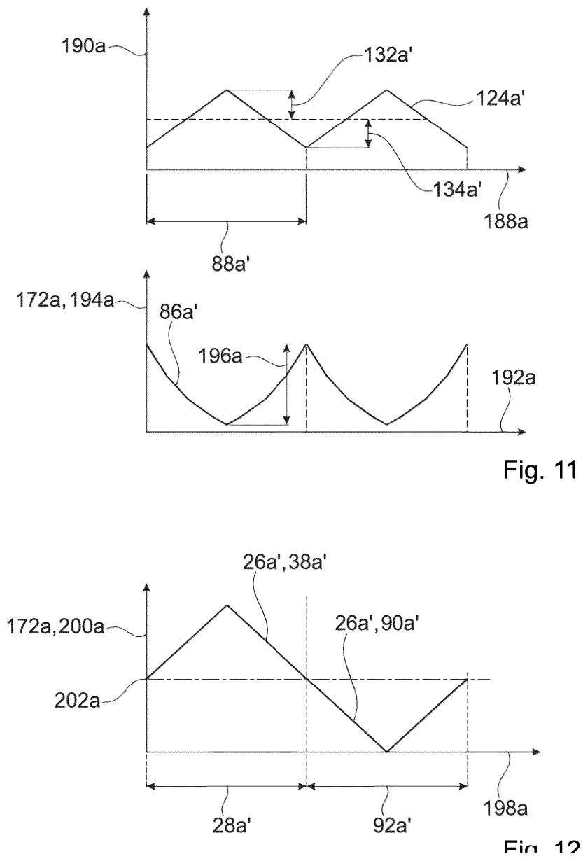

FIG. 11 shows two schematic diagrams for representing the third further modulation profile 86a′ on the basis of which the control unit 18a modulates within the third further modulation period 88a′ the at least one control parameter 26a of the control parameter set, in the present second configuration of the duty cycle 172a, by way of at least one modulation technique, in the present case a further different duty cycle modulation. The third further modulation period 88a′ corresponds to an integer multiple of half the period duration 30a of the mains AC voltage 32a (see FIG. 2). A time is plotted in milliseconds on an x-axis 188a of an upper diagram. A power 124a is plotted in watts on a y-axis 190a of the upper diagram. The time is plotted in milliseconds on an x-axis 192a of a lower diagram. The duty cycle 172a is plotted in percentage values on a y-axis 194a of the lower diagram.

The control unit 18a is provided to vary the third further modulation profile 86a′ at least on the basis of a parameter 40a′ relating to the placement unit 20a or the further placement unit 22a. In the present case, the parameter 40a′ is a target power which is set by a user and which is intended to be provided by the supply induction element 16a for supplying the placement unit 20a. A general path of the third further modulation profile 86a′ is continuous and has a path which is linear at least in some portions. On the basis of the parameter 40a′ the control unit 18a in the operating state varies a duty cycle range 196a of the third further modulation profile 86a′, resulting in the path of the power 124a′ shown in the upper diagram. Due to the duty cycle modulation of the duty cycle 172a, the power 124a′ changes and has an excess 132a′ in some portions and a deficit 134a′ in some portions, so that the power 124a′ considered over the third further modulation period 88a′ corresponds on average to the target power set by the user.

FIG. 12 shows a schematic diagram for representing a chronological sequence of the modulation period 28a′ within which the control unit 18a in the second configuration modulates the control parameter 26a′ configured as a duty cycle 172a on the basis of the modulation profile 38a', and the fourth further modulation period 92a′ within which the control unit 18a in the second configuration modulates the control parameter 26a′ configured as the duty cycle 172a on the basis of the fourth further modulation profile 90a′. A time is plotted in milliseconds on an x-axis 198a of the diagram. The duty cycle 172a is plotted in percentage values on a y-axis 200a of the diagram. As already described, the fourth further modulation profile 92a′ is an inverse of the modulation profile 38a. If the fourth further modulation period 92a′, as shown in FIG. 12, chronologically directly follows the modulation period 28a′ as shown in FIG. 12, it is possible to reduce switching losses of inverter switching elements (not shown) of the inverter of the control unit 18a. The inverter switching elements are arranged in a dual half-bridge configuration so that a duty cycle 172a of 50% is a maximum power duty cycle 202a in which an electrical power inductively provided by one of the supply induction elements 16a of the supply unit 14a is at a maximum (see FIG. 1). A value range of the modulation profile 38a′ comprises values for the duty cycle 172a which are greater than or equal to the maximum power duty cycle 202a. A value range of the fourth further modulation profile 90a′ comprises values for the duty cycle 172a which are less than or equal to the maximum power duty cycle 202a. An average electrical power provided during the modulation period 28a′ by one of the supply induction elements 16a of the supply unit 14a corresponds to an average electrical power provided during the fourth further modulation period 92a′.

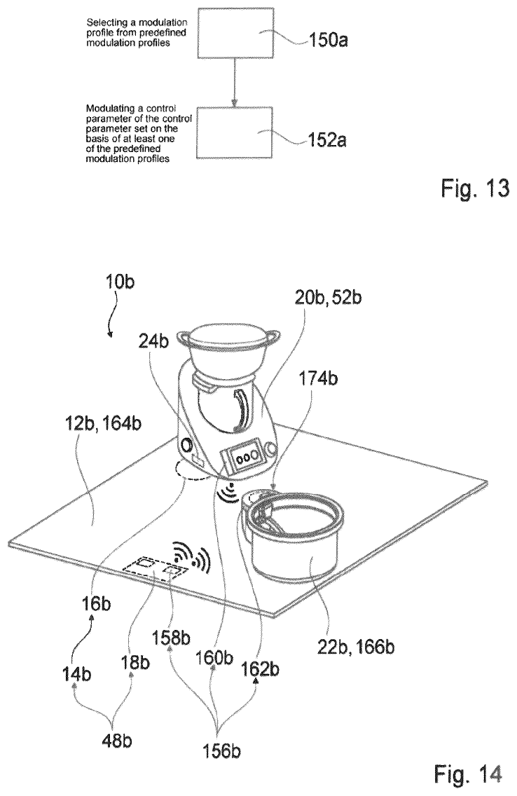

FIG. 13 shows a schematic process flow diagram of a method for operating the induction energy transmission system 10a. In the method, at least one control parameter 26a, 26a′ is modulated for controlling the supply unit 14a within at least one of the modulation periods 28a, 28a′, 80a, 80a′, 84a, 84a′, 88a, 88a′, 92a, 92a′, 182a′ which, in particular, corresponds to an integer multiple of half the period duration 30a of a mains AC voltage 32a, by way of at least one modulation technique. The method comprises at least two method steps 150a, 152a. In a first method step 150a of the method, a modulation profile which is suitable for a current operating situation is selected from the predefined modulation profiles 38a, 38a′, 78a′, 78a′, 82a, 82a′, 86a, 86a′, 90a, 90a′, 180a′. In a second method step 152a of the method, within at least one of the modulation periods 28a, 28a′, 80a, 80a′, 84a, 84a′, 88a, 88a′, 92a, 92a′, 182a′ at least one control parameter 26a, 26a′, in particular the switching frequency 168a and/or the duty cycle 172a, of the control parameter set of the supply unit 14a is modulated on the basis of at least one of the predefined modulation profiles 38a, 38a′, 78a′, 78a′, 82a, 82a′, 86a, 86a′, 90a, 90a′, 180a′.

A further exemplary embodiment of the invention is shown in FIG. 14. The following descriptions are substantially limited to the differences between the exemplary embodiments, wherein relative to components, features and functions remaining the same reference can be made to the description of the exemplary embodiment of FIGS. 1 to 13. For differentiating between the exemplary embodiments, the letter a in the reference signs of the exemplary embodiment of FIGS. 1 to 13 is replaced by the letter b in the reference signs of the exemplary embodiment of FIG. 14. In principle reference can also be made to the drawings and/or the description of the exemplary embodiment of FIGS. 1 to 13 relative to components denoted the same, in particular relative to components having the same reference signs.

FIG. 14 shows a further exemplary embodiment of an induction energy transmission system 10b in a schematic view. The induction energy transmission system 10b has a placement plate 12b and a supply unit 14b. The supply unit 14b is arranged below the placement plate 12b. The supply unit 14b has at least one supply induction element 16b for inductively providing energy. In the present case, the supply unit 14b comprises a total of two supply induction elements 16b. The induction energy transmission system 10b has a control unit 18b which controls the supply unit 14b in an operating state and supplies it with energy. The control unit 18b comprises an inverter (not shown) for controlling and supplying energy to the supply unit 14b. In the operating state, the control unit 18b supplies the supply unit 14b with an electrical energy in the form of a supply alternating current (not shown), the frequency thereof corresponding to a switching frequency (not shown) at which the control unit 18b operates the inverter.

In the operating state, the control unit 18b modulates within a modulation period at least one control parameter (not shown) of a control parameter set of the supply unit 14b by way of at least one modulation technique. Similar to the previous exemplary embodiment, the switching parameter set of the supply unit 14b comprises at least the switching frequency and a duty cycle (not shown) of the supply unit 14b.

The modulation period corresponds to an integer multiple of half a period duration of a mains AC voltage (not shown here see FIG. 2). Reference can be made to the above description of FIGS. 2 to 8 of the previous exemplary embodiment relative to the switching frequency which the control unit 18b in a first configuration modulates by means of at least one frequency modulation. Reference can be made to the above description of FIGS. 9 to 12 of the previous exemplary embodiment relative to the duty cycle which the control unit 18b modulates in a second configuration by means of at least one duty cycle modulation. Reference can be made to the above description of FIG. 13 of the previous exemplary embodiment relative to a method for operating the induction energy transmission system 10b.

In contrast to the previous exemplary embodiment, the induction energy transmission system 10b is configured as a small household appliance supply system and comprises a small appliance supply unit 48b. The small appliance supply unit 48b comprises the control unit 18b and the supply unit 14b. A placement plate 12b of the induction energy transmission system 10b is configured as a kitchen counter-top 164b.

The induction energy transmission system 10b comprises a placement unit 20b to be placed on the placement plate 12b. The placement unit 20b has a receiving induction element 24b for receiving the energy inductively provided by the supply induction element 16b of the supply unit 14b. In the present case, the placement unit 20b is configured as a small household appliance and namely as a food processor 52b. The induction energy transmission system 10b has in the present case a further placement unit 22b. The further placement unit 22b also comprises a receiving induction element (not shown) for receiving the energy inductively provided by the supply induction element 16b of the supply unit 14b. The further placement unit 20b is configured as a cooking utensil 166b. The cooking utensil 166b also has a further unit 174b for providing at least one function which goes beyond purely heating food. In the present case, the further unit 174b is configured as a mixer unit and for mixing food. In the operating state of the induction energy transmission system 10b, the further unit 174b is supplied by means of the energy inductively received by the receiving induction element of the cooking utensil 166b.

The induction energy transmission system 10b has a communication unit 156b for a wireless communication between the control unit 18b and the placement unit 20b and/or the further placement unit 22b. The communication unit 156b has a communication element 158b which is connected to the control unit 18b and two further communication elements 160b, 162b which are arranged in the placement unit 20b or in the further placement unit 22b. In the present case the communication unit 156b is configured as an NFC communication unit and provided for a wireless communication by NFC between the control unit 18b and the placement unit 20b and/or the further placement unit 22b.

### REFERENCE SIGNS

10 Induction energy transmission system
12 Placement plate
14 Supply unit
16 Supply induction element
18 Control unit
20 Placement unit
22 Further placement unit
24 Receiving induction element
26 Control parameter
28 Modulation period
30 Half a period duration
32 Mains AC voltage
34 Modulation interval
36 Modulation interval
38 Modulation profile
40 Parameter
42 Impedance
44 Intermediate modulation period
46 Cooktop
48 Small appliance supply unit
50 Parameter
52 Food processor
54 Kettle
56 X-axis
58 Y-axis
60 Period duration
62 X-axis
64 Y-axis
66 Supply alternating current
68 Average switching frequency
70 X-axis
72 First portion
74 Second portion
76 Axis of symmetry
78 First further modulation profile
80 First further modulation period
82 Second further modulation profile
84 Second further modulation period
86 Third further modulation profile
88 Third further modulation period
90 Fourth further modulation profile
92 Fourth further modulation period
94 X-axis
96 Y-axis
98 First sub-portion
100 First portion
102 Second sub-portion
104 Third sub-portion
106 Axis of symmetry
108 Second portion
110 X-axis
112 Y-axis
114 First portion
116 Second portion
118 Axis of symmetry
120 X-axis
122 Y-axis
124 Power
126 X-axis
128 Y-axis
130 Frequency value range
132 Excess
134 Deficit
136 X-axis
138 Y-axis
140 X-axis
142 Y-axis
144 Excess
146 Deficit
148 Intermediate modulation profile
150 First method step
152 Second method step
154 Cooktop plate
156 Communication unit
158 Communication element
160 Further communication element
162 Further communication element
164 Kitchen counter-top
166 Cooking utensil
168 Switching frequency
170 Y-axis
172 Duty cycle
174 Further unit
176 X-axis
178 Y-axis
180 Fifth further modulation profile
182 Fifth further modulation period
184 X-axis
186 Y-axis
188 X-axis
190 Y-axis
192 X-axis
194 Y-axis
196 Duty cycle range
198 X-axis
200 Y-axis
202 Maximum power duty cycle

1-14. (canceled)

15. An induction energy transmission system, comprising:
a placement plate;
a supply unit arranged below the placement plate and including a supply induction element designed to inductively provide energy, said supply unit including a control parameter set;
a placement unit for placement on the placement plate, said placement unit including a receiving induction element designed to receive the inductively provided energy; and
a control unit controlling the supply unit in an operating state and supplying the supply unit with energy, said control unit being designed to modulate in the operating state a control parameter of the control parameter set within a modulation period using a modulation technique.

16. The induction energy transmission system of claim 15, constructed in a form of an induction cooking system.

17. The induction energy transmission system of claim 15, wherein the control parameter set comprises a switching frequency of the supply unit, with the control unit designed to modulate the switching frequency within the modulation period using a frequency modulation as the modulation technique.

18. The induction energy transmission system of claim 15, wherein the control parameter set comprises a duty cycle of the supply unit, with the control unit designed to modulate within the modulation period using a duty cycle modulation as the modulation technique.

19. The induction energy transmission system of claim 15, wherein the modulation period corresponds to an integer multiple of half a period duration of a mains AC voltage.

20. The induction energy transmission system of claim 15, wherein the modulation period comprises at least two modulation intervals which each correspond to an integer multiple of half a period duration of a mains AC voltage.

21. The induction energy transmission system of claim 20, wherein the at least two modulation intervals differ from one another.

22. The induction energy transmission system of claim 15, wherein the control unit is designed to modulate within the modulation period the control parameter of the control parameter set based on a predefined modulation profile.

23. The induction energy transmission system of claim 15, wherein the control unit is designed to modulate within a further modulation period another control parameter of the control parameter set based on a further modulation profile which is an inverse of the predefined modulation profile.

24. The induction energy transmission system of claim 22, wherein the modulation profile is described by a continuous mathematical function.

25. The induction energy transmission system of claim 22, wherein the modulation profile within the modulation period has a linear path at least in one portion.

26. The induction energy transmission system of claim 22, wherein the modulation profile within the modulation period has an exponential path at least in one portion.

27. The induction energy transmission system of claim 22, wherein the modulation profile within the modulation period is mirror-symmetrical at least in one portion.

28. The induction energy transmission system of claim 15, further comprising a cooktop designed to comprise the control unit and the supply unit.

29. The induction energy transmission system of claim 15, further comprising a small appliance supply unit designed to comprise the control unit and the supply unit.

30. A method for operating an induction energy transmission system, the method comprising:
inductively providing energy by a supply induction element of a supply unit arranged below a placement plate;
transmitting the inductively provided energy to a receiving induction element of a placement unit placed on the placement plate; and
modulating a control parameter of a control parameter set of the supply unit within a modulation period by way of a modulation technique.

31. The method of claim 30, wherein the control parameter is a switching frequency of the supply unit, with the switching frequency being modulated within the modulation period using a frequency modulation as the modulation technique, or the control parameter is a duty cycle of the supply unit, with the duty cycle being modulated within the modulation period using a duty cycle modulation as the modulation technique.

32. The method of claim 30, wherein the control parameter of the control parameter set is modulated within the modulation period based on a predefined modulation profile.

33. The method of claim 30, further comprising modulating within a further modulation period another control parameter of the control parameter set based on a further modulation profile which is an inverse of the predefined modulation profile.

34. The method of claim 32, wherein the modulation profile is described by a continuous mathematical function, or the modulation profile has within the modulation period a linear path at least in one portion, or the modulation profile has within the modulation period an exponential path at least in one portion, or the modulation profile is mirror-symmetrical within the modulation period at least in one portion.
